(19) United States
(12) Patent Application Publication
(10) Pub. No.: US 2022/0213818 A1
(43) Pub. Date: Jul. 7, 2022

(54) DUAL-CYCLE SYSTEM FOR COMBINED-CYCLE POWER PLANT

(71) Applicants: Mitsubishi Power Americas, Inc., Lake Mary, FL (US); Mitsubishi Power, Ltd., Yokohama-shi (JP)

(72) Inventor: Benjamin Shimin Deng, Lake Mary, FL (US)

(73) Assignee: Mitsubishi Power, Ltd., Yokohama-Shi (JP)

(21) Appl. No.: 17/609,145

(22) PCT Filed: May 10, 2019
(86) PCT No.: PCT/US2019/031697

§ 371 Date: Nov. 5, 2021

(51) Int. Cl. F01K 23/10; F01K 25/10; F01K 7/16

(52) U.S. Cl. CPC F01K 23/10; F01K 7/16; F01K 25/10

(57) ABSTRACT

A gas turbine combined-cycle power plant comprising a gas turbine engine comprising a compressor for generating compressed air, a combustor that can receive a fuel and the compressed air to produce combustion gas and a turbine for receiving the combustion gas and generating exhaust gas; a heat recovery steam generator for generating steam from water utilizing heat from the exhaust gas; a steam turbine for producing power from the steam generated by the heat recovery steam generator; a fuel regasification and expansion system in fluid communication with and disposed downstream of the fuel regasification and expansion system for producing power from gasified fuel; and a fuel expansion turbine in fluid communication with and disposed downstream of the fuel regasification and expansion system for producing power from gasified fuel. In examples, the power plant can include an Organic Rankine Cycle (ORC) using heat input from the heat recovery steam generator. The ORC can utilize a recupertor to redistribute heat within the ORC.

### TECHNICAL FIELD

This document pertains generally, but not by way of limitation, to combined-cycle power plants utilizing a gas turbine engine, a heat recovery steam generator, and a steam turbine. More specifically, but not by way of limitation, the present application relates to systems for increasing the efficiency of combined-cycle power plants via addition of a secondary cycle, such as that utilizing liquefied natural gas cold energy.

### BACKGROUND

In a gas turbine combined-cycle (GTCC) power plant, a gas turbine engine can be operated to directly generate electricity with a generator using shaft power. Hot exhaust gas of the gas turbine engine can additionally be used to generate steam within a heat recovery steam generator (HRSG) that can be used to rotate a steam turbine shaft to further produce electricity.

Natural gas is frequently used in GTCC power plants as fuel for gas turbine engines. Natural gas is the second largest source of energy globally and is expected to remain in that position for the foreseeable future. A major component of the natural gas market is liquefied natural gas (LNG) which is used to transport natural gas worldwide. Typically, LNG is currently regasified through open rack vaporizers using heat from seawater at receiving terminals where the LNG is received. The regasification process results in localized cooling of the seawater, which presents environmental challenges including negative impacts on marine life.

Organic Rankine Cycles (ORCs) have been used to take advantage of cold energy available in LNG, using seawater as a heat source. However, such systems can be limited in their application.

Examples of liquid natural gas regasification and expansion systems are described in U.S. Pat. No. 9,903,232 to Amir et al.; U.S. Pat. No. 6,116,031 to Minta et al; and U.S. Pat. No. 4,320,303 to Ooka et al.

### OVERVIEW

The present inventor has recognized, among other things, that problems to he solved in GTCC power plants can include inefficient utilization of the inherent cold energy from LNG. A significant amount of energy is consumed to cool and liquefy natural gas for producing low-temperature (about −160° C.) LNG that can be readily stored and transported. The inherent cold energy/energy available from the low-temperature LNG is not being effectively utilized during regasifi cation.

The present subject matter can help provide a solution to this problem and other problems, such as by using an Organic Rankine Cycle (ORC) to utilize low pressure water from a heat recovery steam generator (HRSG) as a heat source and LNG as a cold sink. In parallel, direct natural gas expansion cycle also produces electricity by expanding the pressurized and regasified fuel. The combination of an ORC cycle and an fuel expansion cycle (direct natural gas expansion cycle) into a dual-cycle system can be utilized to power an additional turbine for generating electricity, improving the overall efficiency of a GTCC power plant.

In an example, a gas turbine combined-cycle power plant can comprise a gas turbine engine, a heat recovery steam generator, a steam turbine, a fuel regasification system and a fuel expansion turbine (also referred to herein collectively as a “fuel regasification and expansion system”). The gas turbine engine can comprise a compressor for generating compressed air, a combustor that can receive a fuel and the compressed air to produce combustion gas, and a turbine for receiving the combustion gas and generating exhaust gas. The heat recovery steam generator can be configured to generate steam from water utilizing heat from the exhaust gas. The steam turbine can be configured to produce power from steam generated by the heat recovery steam generator. The fuel regasification system can be configured to be in fluid communication with and disposed upstream of the combustor for converting the fluid from a liquid to a gas. The fuel expansion turbine can be configured to be in fluid communication with and disposed downstream of the fuel regasification process for producing power from gasified fuel.

In another example, an Organic Rankine Cycle (ORC) system for operation with a gas turbine combined-cycle power plant can comprise a fluid pump for pumping a fluid, an ORC turbine in fluid communication with and disposed downstream form the fluid pump for expanding the fluid, a regasification system for a fuel configured to cool the fluid between an outlet of the ORC turbine and an inlet of the pump, a first heat exchanger positioned between an outlet of the pump and an inlet of the ORC turbine to heat the fluid with heat from a heat recovery steam generator of the gas turbine combined-cycle power plant, and a fuel expansion turbine to produce power from the regasified fuel before it enters a gas turbine engine of the gas turbine combined-cycle power plant.

In an additional example, a method of operating a gas turbine combined-cycle power plant can comprise circulating a working fluid through a closed loop using a working pump, heating the working fluid with a first heat exchanger using heat from the gas turbine combined-cycle power plant, expanding the heated working fluid through a working fluid turbine, condensing the working fluid leaving the turbine with a liquid fuel regasification process, expanding gas fuel through a fuel turbine, and generating electrical power with the working fluid turbine and the fuel turbine.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1 is a schematic diagram illustrating a conventional Gas Turbine Combined Cycle (GTCC) power plant operating a gas turbine in conjunction with a Heat Recovery Steam Generator (HRSG) and steam turbine.

FIG. 2 is a schematic diagram illustrating a Gas Turbine Combined Cycle (GTCC) power plant of the present application having a dual-cycle system using a working fluid turbine and natural gas turbine to generate additional power.

FIG. 3 is a schematic diagram illustrating a dual-cycle system incorporating the ORC system of FIG. 2 and a liquid natural gas (LNG) regasification and expansion system.

FIG. 4 is a graph showing a temperature-entropy (T-s) diagram of the ORC system and the LNG regasification and expansion system cycles of FIG. 3.

FIG. 5 is a line diagram illustrating steps of a method for operating the ORC system and the LNG regasification and expansion system of FIG. 3.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

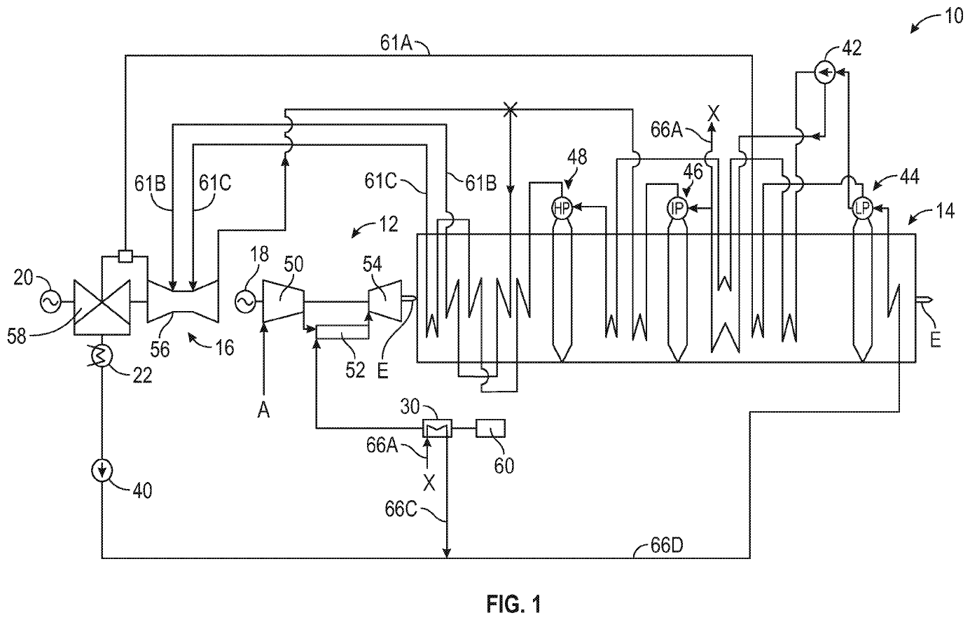

FIG. 1 is a schematic diagram illustrating a conventional Gas Turbine Combined Cycle (GTCC) power plant 10 having gas turbine engine (GTE) 12, Heat Recovery Steam Generator (HRSG) 14 and steam turbine 16. GTE 12 can be used in conjunction with electrical generator 18, and steam turbine 16 can be used in conjunction with electrical generator 20. Power plant 10 can also include condenser 22, fuel gas heater 30, condensate pump 40 and feedwater pump 42. HRSG 14 can include low pressure section 44, intermediate pressure section 46 and high pressure section 48. Condenser 22 can form part of a cooling system and can comprise a surface condenser with seawater once-through cooling. GTE 12 can include compressor 50, combustor 52 and turbine 54. Steam turbine 16 can include IP/HP spool 56 and LP spool 58.

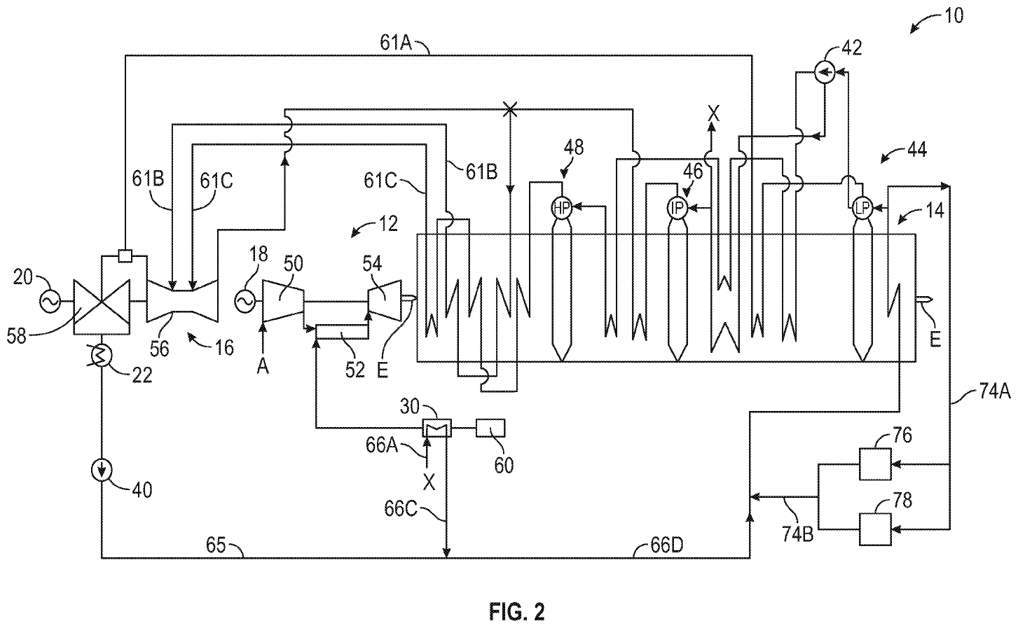

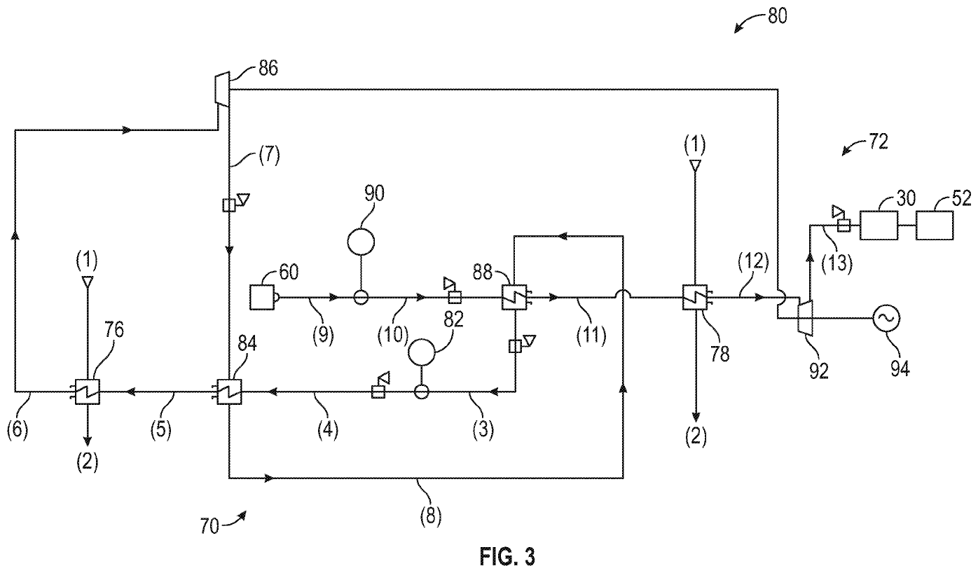

As will be discussed in greater detail below with reference to FIGS. 2 and 3, water can be supplied from HRSG 14 to provide heat exchanging functions with an Organic Rankine Cycle (ORC) system (ORC system 70 of FIG. 3) and a Liquid Natural Gas (LNG) regasification and expansion system (LNG regasification and expansion system 72 of FIG. 3). The operation of GTCC power plant 10 is described with reference to FIG. 1 operating without ORC system 70 and LNG regasification and expansion system 72.

Ambient air A can enter compressor 50. The compressed air is fed to combustor 52 and mixed with fuel from fuel source 60, which can be a source of natural gas or regasified LNG. The compressed air from compressor 50 is mixed with the fuel for combustion in combustor 52 to produce high energy gas for turning turbine 54. Rotation of turbine 54 is used to produce rotational shaft power to drive compressor 50 and electrical generator 18. Exhaust gas E is directed to HRSG 14, where exhaust gas E interacts with appropriate water/steam piping in high pressure section 48, intermediate pressure section 46 and low pressure section 44 to produce steam. The steam is routed to IP/HP spool 56 and LP spool 58 of steam turbine 16 via steam lines 61C, 61B and 61A to produce rotational shaft power to operate electrical generator 20. Exhaust gas E can exit HRSG 14 utilizing any appropriate venting means, such as a stack. HRSG 14 can additionally include appropriate means for conditioning exhaust gas E to remove potentially environmentally hazardous materials. For example, HRSG 14 can include a Selective Catalytic Reduction (SCR) emissions reduction unit.

Water from HRSG 14 can also be used to perform fuel heating at fuel gas heater 30 with water line 66A, as is shown by arrows X-X, and water can then be returned to low pressure section 44 via lines 66C and 66D.

Heat remaining in flue gas downstream of low pressure section 44 of HRSG 14 is typically wasted, resulting only in an increase of the temperature of exhaust gas E exiting HRSG 14. In the present disclosure, ORC system 70 (FIG. 3) can be connected in thermal communication with HRSG 14 and low-temperature LNG from regasification and expansion system 72 (FIG. 3) to turn one or more additional turbines for generating electrical power.

FIG. 2 is a schematic diagram illustrating a Gas Turbine Combined Cycle (GTCC) power plant 10 of FIG. 1 modified according to the present disclosure to include ORC system 70 (FIG. 3) that uses water from HRSG 14 as a heat source and. Liquified Natural Gas (LNG) from regasification and expansion system 72 (FIG. 3) as a cold sink. FIG. 2 utilizes the same reference numbers where appropriate to indicate the same or functionally equivalent components as FIG. 1, with new reference numbers are added to indicate additional components.

In particular, lines 74A and 74B are added to connect first heat exchanger 76 and second heat exchanger 78 into operation of HRSG 14. In the illustrated example, heat exchangers 76 and 78 are shown connected in parallel. to other examples, heat exchangers 76 and 78 can be connected in series, with either one being configured to be first. As discussed with reference to FIG. 3, first heat exchanger 76 can comprise a portion of ORC system 70 and second heat exchanger 78 can comprise a portion of LNG regasification and expansion system 72. ORC system 70 and LNG regasification and expansion system 72 together comprise dual-cycle system 80 that can be integrated into operating with GTCC power plant 10, as shown in FIG. 2, to increase the overall efficiency and output of GTCC power plant 10.

Line 74A can be positioned to extract low pressure water from HRSG 14 at low pressure section 44. In other examples, line 74A can be connected to intermediate pressure section 46 or high pressure section 48. In examples, line 74A can be configured to extract steam from HRSG 14. Additional low pressure water in line 74A from low pressure section 44 contains heat that is otherwise wasted if it is not produced and utilized. ORC system 70 and regasification and expansion system 72 can utilize this readily available heat source, without impacting the performance of GTCC power plant 10, to generate additional power and increase the overall efficiency of GTCC power plant 10. Line 74B can return the low pressure water that has been cooled by ORC system 70 and regassification and expansion system 72 in heat exchangers 76 and 78 to an inlet of low pressure section 44 to further cool exhaust gas E before exhaust gas E leaves HRSG 14 and is vented to atmosphere.

FIG. 3 is a schematic diagram illustrating dual-cycle system 80 including ORC system 70 and regasification and expansion system 72. In an example, ORC system 70, propane may be used as a working fluid, and ORC system 70 can include working fluid pump 82, fourth heat exchanger (functioning as a recuperator) 84, first heat exchanger (functioning as a propane superheater) 76, working fluid turbine 86 and third heat exchanger (functioning as a propane condenser) 88. Regasification and expansion system 72 can comprise fuel source 60, fuel pump 90, third heat exchanger (functioning as a fuel vaporizer and also herein referred to as a “gasification heat exchanger”) 88, second heat exchanger (functioning as a fuel superheater) 78 and fuel turbine 92. Working fluid turbine 86 and fuel turbine 92 can be configured to drive generator 94. Regasification and expansion system 72 can be fluidly coupled to fuel gas heater 30 and combustor 52.

As compared to the system of FIG. 1, additional power can be generated using working fluid turbine 86 and fuel turbine 92. In ORC system 70, heat energy can be extracted from GTCC power plant 10 from low pressure section 44 of HRSG 14 at heat exchanger 76. Heat exchanger 88 can be used as a cold sink to condense the working fluid. Furthermore, in the regasification and expansion system 72, heat energy can be extracted from GTCC power plant 10 from low pressure section 44 of HRSG 14 at heat exchanger 78, which can increase the temperature of fuel fed to fuel turbine 92. The dual-cycle system 80 can reduce temperature of exhaust gas E (FIG. 2) leaving the HRSG. Because LNG has improved fuel quality (relative to standard natural gas) and does not contain Sulphur, it is acceptable for the stack temperature of the system of FIG. 2 to be lower than a conventional GTCC power plant, such as that of FIG. 1.

In an embodiment, the working fluid of ORC system 70 can be propane (C₃H₈). However, in other embodiments, other fluids can be used. For example, various organic compounds can be used. In other embodiments, CO₂, hydro-carbon fluids, ammonia (NH₃) and H₂S can be used. Although other fluids may yield increased thermal efficiency, propane is commonly used in the industry.

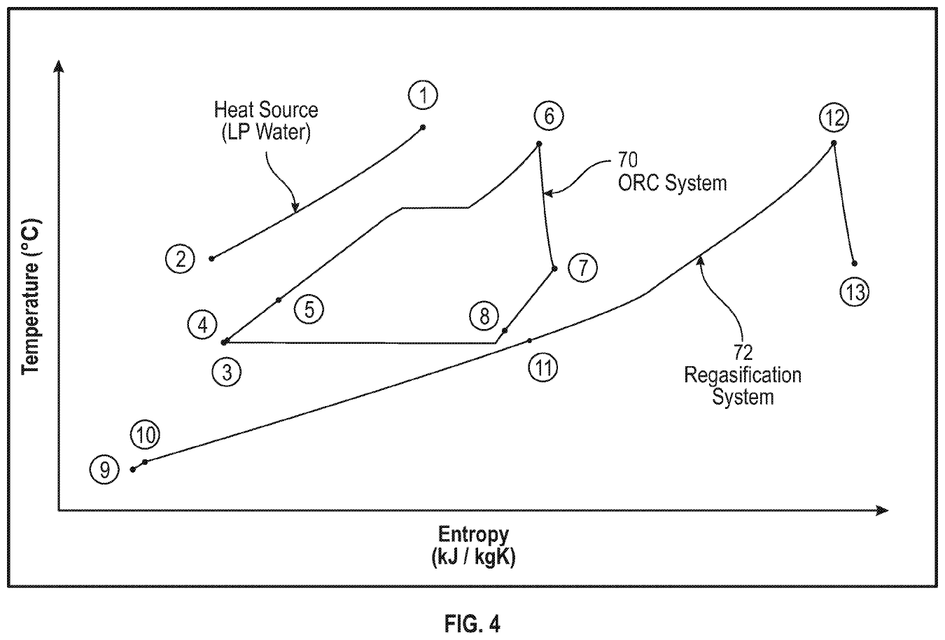

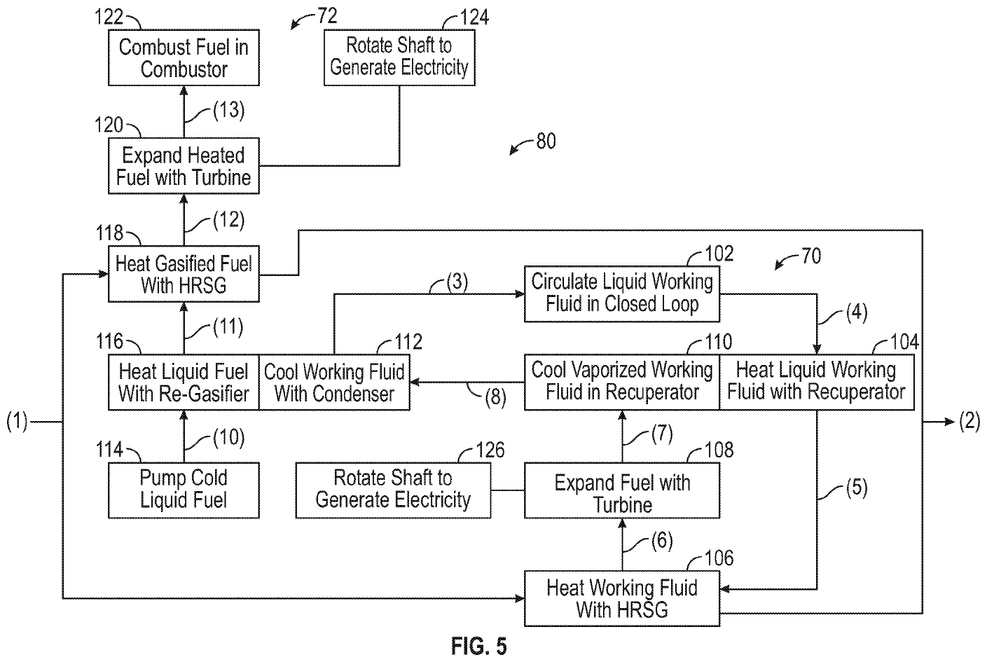

FIG. 3 has been provided with parenthetical reference numbers (1)-(13) to identify locations within dual-cycle system 80. Locations (1)-(13) are described with reference to FIG. 3 to discuss the operation of system 80. Locations (1)-(13) are also mapped to a temperature-entropy (T-s) diagram in FIG. 4 and a process flow chart in FIG. 5.

Low pressure water is extracted from HRSG 14 at location (1). This low-pressure water can be provided to first heat exchanger 76 and second heat exchanger 78 in parallel as shown in FIG. 2. After this low-pressure water has been cooled in heat exchangers 76 and 78, e.g., after heat has been extracted from the low pressure water to increase the temperature of the working fluid in ORC system 70 and the fuel of regasification and expansion system 72, the low-pressure water can be returned to HRSG 14 at location (2).

ORC system 70 can start at third heat exchanger 88, which can function as a condenser for ORC system 70 and a gasifier for regasification and expansion system 72. At third heat exchanger 88, propane gas can be condensed to a liquid at location (3) and can flow into working fluid pump 82. The liquid propane can be pumped by pump 82 to a higher pressure at (4) and then heated to a higher temperature using recuperator 84 at (5). First heat exchanger 76 can gasify and superheat the propane at (6). The superheated propane can then continue to working fluid turbine 86 where the superheated propane can be expanded at (7). Finally, the propane can pass through recuperator 84 where it is cooled at (8) before returning to third heat exchanger 88 where the propane is condensed to a liquid.

Liquid natural gas from fuel source 60 can flow to pump 90 at (9). Pump 90 can increase the temperature and pressure of the liquid natural gas at (10). Next, the liquid natural gas can flow through third heat exchanger 88 where it can vaporize at (11). The vaporized natural gas can then be superheated in second heat exchanger 78 at (12). Fuel turbine 92 can then be used to expand the superheated natural gas at (13). Finally, the natural gas is passed through fuel gas heater 30 and then into combustor 52 for combustion in gas turbine engine 12 (FIG. 2).

Working fluid turbine 86 and fuel turbine 92 can be used to extract energy from the working fluid (e.g., propane) and the fuel (e.g. natural gas), respectively. In examples, turbines 86 and 92 can be coupled to a common shaft to drive a single generator, such as generator 94. In other examples, each of turbine 86 and 92 can be provided with a separate output shaft for driving separate independent electrical generators.

The operation of GTCC power plant 10, ORC system 70 and fuel regasification and expansion system 72 can be modeled with software, and in an example GTCC system 10 was modeled using GTPro software and dual-cycle system 80 was modeled with Ebsilon software. An exemplary power plant for modeling purposes can include an arrangement of two 2-on-1 GTCC power islands using advanced-class gas turbines. The steam bottoming cycle is based on a typical HRSG arrangement which features three pressure levels (RP, IP and LP) with reheat. The simulation was based on typical ambient conditions in Caribbean regions: 1.013 bar, dry bulb temperature of 28° C., and relative humidity of 85%. It was assumed that LNG consists of pure methane (CH₄).

Two cases were simulated. In the first Base Case, conventional GTCC power plant 10 of FIG. 1 was simulated using liquid natural gas (LNG) fuel, using GTPro software. In the second Improved Case, modified GTCC power plant 10 of FIG. 2 was simulated using LNG fuel, and dual-cycle system 80 with ORC system 70 and regasification and expansion system 72. The simulation results indicated that a 0.73% points plant net efficiency (LHV) increase can be achieved.

The Improved Case (FIG. 2) results in no negative impact to the output of GTCC system 10, relative to the Base Case (FIG. 1). As such, the additional power produced by generator 94 can be obtained at little or no cost.

In the Improved Case of the present application, the stack temperature of HRSG 14 can be lower than a conventional combined cycle. For the simulated cases, the stack temperature can be reduced to about 60° C. Such a temperature is acceptable because: A) LNG is considered as being a “Sulphur free” fuel, so concern related to the flue gas dewpoint is mitigated; and B) it is still higher than minimum flue gas temperature for discharging to the stack with adequate buoyancy (50° C., typical).

FIG. 4 is a graph showing a temperature-entropy (T-s) diagram of low pressure water from HRSG 14 between locations (1) and (2), ORC system 70 and regasification and expansion system 72 of FIG. 3. FIG. 4 indicates that, by utilizing the “free” heat energy available between locations (1) and (2) in HRSG 14 and the cold sink available from the liquid natural gas, such as at fuel source 60, ORC system 72 can be driven to obtain shaft power at turbine 86. Furthermore, the liquid natural gas can be heated with both ORC system 70 and the water from HRSG 14 between (1) and (2) to drive fuel turbine 92. Temperature of the natural gas provided to the fuel gas heater 30 (downstream of the fuel turbine 92) in inventive embodiments such as depicted by FIG.2 is substantially the same as the temperature of natural gas provided to the fuel gas heater 30 by typical LNG gasification systems as depicted by FIG. 1.

FIG. 5 is a line diagram illustrating steps of method 100 for operating dual-cycle system 80 of FIG. 3. At step 102, an organic working fluid can be circulated through a closed-circuit loop using a pump, such as pump 82. At step 104, organic working fluid leaving the pump 82 can be heated by recuperator 84, using heat from another portion of ORC system 70. At step 106, the organic working fluid can be superheated with first heat exchanger 76 using heat from HRSG 14. At step 108, the superheated and gasified working fluid can be expanded with turbine 86. At step 110, the expanded working fluid can be passed through recuperator 84 for cooling. At step 112, the working fluid can be condensed into a liquid using third heat exchanger 88 before returning to pump 82.

At step 114, fuel can be pumped from fuel source 60 using pump 90. The fuel can be pumped to third heat exchanger 88, where, at step 116, the liquid fuel can be heated and gasified. At step 118, the gasified fuel can be superheated using second heat exchanger 78. At step 120, the fuel can be expanded in turbine 92. At step 122, the fuel can pass into combustor 52 (FIG. 2), such as after passing through fuel gas heater 30, for combustion.

Operation of ORC system 70 and regasification and expansion system 72 together as dual-cycle system 80 can be used to generate electricity with turbines 92 and 86 at steps 124 and 126, respectively.

The systems and methods of the present application result in a significant performance improvement that can he achieved by application of a dual-cycle in a LNG-fueled GTCC power plant. ORC system 70 can utilize a recuperator to effectively redistribute heat within ORC system 70 to improve the performance of regasification and expansion system 72 and ORC 70. Such operation of ORC system 70 and regasification and expansion system 72 can allow the dual-cycle system 80 to power turbines that can be used to generate additional electricity, thereby improving the overall efficiency of the LNG-fueled GTCC power plant. In addition, an environmental benefit can be achieved by avoiding the cooling of seawater in the LNG regasification process.

### Various Notes & Examples

Example 1 can include or use subject matter such as a gas turbine combined-cycle power plant comprising a gas turbine engine comprising a compressor for generating compressed air, a combustor that can receive a fuel and the compressed air to produce combustion gas and a turbine for receiving the combustion gas and generating exhaust gas; a heat recovery steam generator for generating steam from water utilizing heat from the exhaust gas; a steam turbine for producing power from the steam generated by the heat recovery steam generator; a fuel regasification system for converting the fuel from a liquid to a gas before entering the combustor; and; and a fuel expansion turbine in fluid communication with and disposed downstream of the fuel regasification system for producing power from gasified fuel.

Example 2 can include, or can optionally be combined with the subject matter of Example 1, to optionally include an Organic Rankine Cycle (ORC) system configured to vaporize liquid fuel entering the fuel regasification and expansion system.

Example 3 can include, or can optionally be combined with the subject matter of one or any combination of Examples 1 or 2 to optionally include an ORC comprising a fluid pump for pumping a fluid, an ORC turbine in fluid communication with and disposed downstream of the pump for expanding the fluid, a first ORC heat exchanger in fluid communication with and positioned between the pump and the ORC turbine to heat the fluid with low pressure water from the heat recovery steam generator and a cooling source in fluid communication with and disposed between the ORC turbine and the pump for cooling the fluid.

Example 4 can include, or can optionally be combined with the subject matter of one or any combination of Examples 1 through 3 to optionally include a recuperator positioned between the fluid pump and the first ORC heat exchanger to exchange heat between the fluid flowing from the fluid pump and the fluid flowing from the ORC turbine.

Example 5 can include, or can optionally be combined with the subject matter of one or any combination of Examples 1 through 4 to optionally include a fluid comprising propane.

Example 6 can include, or can optionally be combined with the subject matter of one or any combination of Examples 1 through 5 to optionally include a cooling source comprising liquid fuel from the fuel regasifi cation and expansion system.

Example 7 can include, or can optionally be combined with the subject matter of one or any combination of Examples 1 through 6 to optionally include a fuel regasification and expansion system comprising a fuel pump for receiving liquefied fuel, a third ORC heat exchanger in fluid communication with and disposed downstream from the fuel pump, the third ORC heat exchanger configured to function as a condenser for the ORC system, and a second ORC heat exchanger for heating gasified fuel flowing from the third ORC heat exchanger.

Example 8 can include, or can optionally be combined with the subject matter of one or any combination of Examples 1 through 7 to optionally include a fuel heat exchanger that can transfer heat from low pressure water from the heat recovery steam generator to gasified fuel.

Example 9 can include, or can optionally be combined with the subject matter of one or any combination of Examples 1 through 8 to optionally include a liquid fuel comprising liquified natural gas.

Example 10 can include or use subject matter such as an Organic Rankine Cycle (ORC) system for operation with a gas turbine combined-cycle power plant that can comprise a fluid pump for pumping a fluid, an ORC turbine in fluid communication with and disposed downstream from the fluid pump for expanding the fluid, a regasification and expansion system for a fuel configured to cool the fluid between an outlet of the ORC turbine and an inlet of the pump, a first heat exchanger positioned between an outlet of the pump and an inlet of the ORC turbine to heat the fluid with heat from a heat recovery steam generator of the gas turbine combined-cycle power plant, and a fuel expansion turbine to produce power from the fuel before it enters a gas turbine engine of the gas turbine combined-cycle power plant.

Example 11 can include, or can optionally be combined with the subject matter of Example 10, to optionally include a recuperator positioned between an outlet of the fluid pump and an inlet of the first heat exchanger to exchange heat between the fluid leaving the fluid pump and the fluid leaving the ORC turbine.

Example 12 can include, or can optionally be combined with the subject matter of one or any combination of Examples 10 or 11 to optionally include a second heat exchanger in thermal communication with the fuel and the heat recovery steam generator.

Example 13 can include, or can optionally be combined with the subject matter of one or any combination of Examples 10 through 12 to optionally include a second heat exchanger that is configured to heat the fuel with low pressure water from the heat recovery steam generator.

Example 14 can include, or can optionally be combined with the subject matter of one or any combination of Examples 10 through 13 to optionally include a third heat exchanger in thermal communication with the fuel and the fluid to transfer heat from the fluid to vaporize the fuel.

Example 15 can include, or can optionally be combined with the subject matter of one or any combination of Examples 10 through 14 to optionally include a fuel regasification and expansion system that can comprise a fuel pump for receiving liquefied fuel, a third heat exchanger disposed downstream of an din fluid communication with the fuel pump, a second heat exchanger disposed downstream of and in fluid communication with the third heat exchanger and the fuel turbine to receive fuel from the second heat exchanger.

Example 16 can include or use subject matter such as a method of operating a gas turbine combined-cycle power plant comprising circulating a working fluid through a closed loop using a working pump, heating the working fluid with a first heat exchanger using heat from the gas turbine combined-cycle power plant, expanding the heated working fluid through a working fluid turbine, condensing the working fluid leaving the turbine with a fuel regasification and expansion system, expanding gas fuel of the fuel regasification and expansion system through a fuel turbine and generating electrical power with the working fluid turbine and the fuel turbine.

Example 17 can include, or can optionally be combined with the subject matter of Example 16, to optionally include cooling the working fluid leaving the working fluid turbine with a recuperator receiving working fluid from the working pump.

Example 18 can include, or can optionally be combined with the subject matter of one or any combination of Examples 16 or 17 to optionally include heating the working fluid with a first external heat source by heating the working fluid with water from a heat recovery steam generator of the gas turbine combined-cycle power plant.

Example 19 can include, or can optionally be combined with the subject matter of one or any combination of Examples 16 through 18 to optionally include heating the fuel using a second heat exchanger in thermal communication with the water from the heat recovery steam generator.

Example 20 can include, or can optionally be combined with the subject matter of one or any combination of Examples 16 through 19 to optionally include cooling the fluid leaving the turbine with a fuel regasification and expansion system by pumping liquefied natural gas with a fuel pump through a regasification heat exchanger in thermal communication with the working fluid upstream of the working pump, transferring heat from the working fluid to the liquefied natural gas in the regasification heat exchanger to gasify the liquefied natural gas and condense the working fluid, heating the gasified natural gas in the second heat exchanger and providing the gasified natural gas to a gas turbine of the gas turbine combined-cycle power plant.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAM), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A gas turbine combined-cycle power plant comprising:
a gas turbine engine comprising:
a compressor for generating compressed air;
a combustor that can receive a fuel and the compressed air to produce combustion gas; and
a turbine for receiving the combustion gas and generating exhaust gas;
a heat recovery steam generator for generating steam from water utilizing heat from the exhaust gas;
a steam turbine for producing power from the steam generated by the heat recovery steam generator;
a fuel regasification system for converting the fuel from a liquid to a gas before entering the combustor; and
a fuel expansion turbine in fluid communication with and disposed downstream of the fuel regasification system for producing power from gasified fuel.

2. The gas turbine combined-cycle power plant of claim 1, further comprising:
an Organic Rankine Cycle (ORC) system configured to vaporize liquid fuel entering the fuel regasification and expansion system.

3. The gas turbine combined-cycle power plant of claim 2, wherein the ORC system comprises:
a fluid pump for pumping a fluid;
an ORC turbine in fluid communication with and disposed downstream of the pump for expanding the fluid;
a first ORC heat exchanger in fluid communication with and positioned between the pump and the ORC turbine to heat the fluid with low pressure water from the heat recovery steam generator; and
a cooling source in fluid communication with and disposed between the ORC turbine and the pump for cooling the fluid.

4. The gas turbine combined-cycle power plant of claim 3, further comprising a recuperator positioned between the fluid pump and the first ORC heat exchanger to exchange heat between the fluid flowing from the fluid pump and the fluid flowing from the ORC turbine.

5. The gas turbine combined-cycle power plant of claim 3, wherein the fluid comprises propane.

6. The gas turbine combined-cycle power plant of claim 3, wherein the cooling source comprises liquid fuel from the fuel regasification and expansion system.

7. The gas turbine combined-cycle power plant of claim 6, wherein the fuel regasification and expansion system comprises:
a fuel pump for receiving liquefied fuel;
a third ORC heat exchanger in fluid communication with and disposed downstream of the fuel pump, the third ORC heat exchanger configured to function as a condenser for the Organic Rankine Cycle system; and
a second ORC heat exchanger disposed downstream from the third ORC heat exchanger for heating gasified fuel flowing from the third ORC heat exchanger.

8. The gas turbine combined-cycle power plant of claim 7, wherein the fuel heat exchanger transfers heat from water from the heat recovery steam generator to the gasified fuel.

9. The gas turbine combined-cycle power plant of claim 7, wherein the liquefied fuel comprises liquified natural gas.

10. An Organic Rankine Cycle (ORC) system for operation with a gas turbine combined-cycle power plant comprising a fuel system, the ORC system comprising:
a fluid pump for pumping a fluid;
an ORC turbine in fluid communication with and disposed downstream from the fluid pump, the ORC turbine for expanding the fluid;
a regasification and expansion system for a fuel of the fuel system, the regasification and expansion system configured to cool the fluid between an outlet of the ORC turbine and an inlet of the pump;
a first heat exchanger positioned between an outlet of the pump and an inlet of the ORC turbine to heat the fluid with heat from a heat recovery steam generator of the gas turbine combined-cycle power plant; and
a fuel expansion turbine of the fuel system to produce power from the fuel before it enters a gas turbine engine of the gas turbine combined-cycle power plant.

11. The Organic Rankine Cycle system of claim 10, further comprising a recuperator positioned between an outlet of the fluid pump and an inlet of the first heat exchanger to exchange heat between the fluid leaving the fluid pump and the fluid leaving the ORC turbine.

12. The Organic Rankine Cycle system of claim 11, further comprising a second heat exchanger in thermal communication with the fuel and the heat recovery steam generator.

13. The Organic Rankine Cycle system of claim 12, wherein the second heat exchanger is configured to heat the fuel with low pressure water from the heat recovery steam generator.

14. The Organic Rankine Cycle system of claim 12, further comprising a third heat exchanger in thermal communication with the fuel and the fluid to transfer heat from the fluid to vaporize the fuel.

15. The Organic Rankine Cycle system of claim 11, wherein the fuel regasification and expansion system comprises:
a fuel pump for receiving liquefied fuel;
a third heat exchanger disposed downstream of and in fluid communication with the fuel pump;
a second heat exchanger disposed downstream of and in fluid communication with the third heat exchanger; and
the fuel turbine to receive fuel from the second heat exchanger.

16. A method of operating a gas turbine combined-cycle power plant, the method comprising:
circulating a working fluid through a closed loop using a working pump;
heating the working fluid with a first heat exchanger using heat from the gas turbine combined-cycle power plant;
expanding the heated working fluid through a working fluid turbine;
condensing the working fluid leaving the turbine with a fuel regasification and expansion system;
expanding gas fuel of the fuel regasification and expansion system through a fuel turbine; and
generating electrical power with the working fluid turbine and the fuel turbine.

17. The method of claim 16, further comprising cooling the working fluid leaving the working fluid turbine with a recuperator receiving working fluid from the working pump.

18. The method of claim 16, wherein heating the working fluid with a first external heat source comprises heating the working fluid with water from a heat recovery steam generator of the gas turbine combined-cycle power plant.

19. The method of claim 18, further comprising heating the fuel using a second heat exchanger in thermal communication with the water from the heat recovery steam generator.

20. The method of claim 19, wherein cooling the working fluid leaving the working fluid turbine with fuel regasification and expansion system comprises:
pumping liquefied natural gas with a fuel pump through a regasification heat exchanger in thermal communication with the working fluid upstream of the working pump;
transferring heat from the working fluid to the liquefied natural gas in the regasification heat exchanger to gasify the liquefied natural gas and condense the working fluid;
heating the gasified natural gas in the second heat exchanger; and
providing the gasified natural gasified natural gas to a gas turbine of the gas turbine combined-cycle power plant.
